(19) United States
(12) Patent Application Publication
(10) Pub. No.: US 2011/0287272 A1
(43) Pub. Date: Nov. 24, 2011

(54) POLYMER COMPOSITIONS FOR METAL COATING, ARTICLES MADE THEREFROM AND PROCESS FOR SAME

(75) Inventor: Andri E. Elia, Chadds Ford, PA (US)

(73) Assignee: E.I.DU PONT DE NEMOURS AND COMPANY, Wilimington, DE (US)

(21) Appl. No.: 13/141,768

(22) PCT Filed: Dec. 22, 2009
(86) PCT No.: PCT/US09/69111

§ 371 Date: Jun. 23, 2011

Related U.S. Application Data
(60) Provisional application No. 61/140,362, filed on Dec. 23, 2008.

(51) Int. Cl. B32B 15/08; C25D 3/00

(52) U.S. Cl. 428/458; 205/261; 427/250; 427/443.1; 428/457

(57) ABSTRACT

Metal-coated thermoplastic compositions comprising “flat” fibrous reinforcing filler have improved resistance to repeated thermal shock. Disclosed herein are metal coated compositions useful in automotive parts, toys, appliances, power tools, industrial machinery, and the like.

### FIELD OF THE INVENTION

Disclosed herein are polymeric compositions suitable for being metal-coated comprising a thermoplastic polymer and “flat” reinforcing fiber.

### TECHNICAL BACKGROUND

It is well known in the art, and practiced commercially to coat thermoplastic polymers (TPs) with metals. Such coatings are utilized for aesthetic purposes (i.e., chrome plating), to improve the mechanical properties of the polymeric substrate, and to provide other improved properties such as electromagnetic shielding. The metal may be coated onto the TP using a variety of methods, such as electroless or electroplating, vacuum metallization, different sputtering methods, lamination of metal foil onto the thermoplastic, etc.

In any of these methods the resulting product must have certain properties to be useful. Generally-speaking the metal coating should have sufficient adhesion so that it does not separate from the thermoplastic substrate during use. This may be particularly difficult if the product must undergo temperature cycling, that is repeated heating and cooling above and/or below ambient temperature. Since most thermoplastic compositions have different thermal coefficients of expansion than most metals, the repeated heating and cooling cycles may stress the interface between the metal and the TP, resulting in weakening the interface between the TP and metal coating, and eventually in separation of the metal from the TP. Therefore methods and/or compositions for improving the adhesion of TPs to metal coatings, especially in a thermal cycling environment, are desired.

The use of noncircular cross section glass in thermoplastics is known in the art, see for instance European Patent Applications 246,620 and 376,616 and U.S. Patent Publication 20080132633. None of, these describes polymeric compositions which are metal coated.

### SUMMARY OF THE INVENTION

Disclosed: herein is 1. An article, comprising, a composition comprising:

(a) at least about 30 weight percent of a thermoplastic; and (b) about 5 to to about 70 percent by weight of flat reinforcing fiber; wherein said weight percents are based on the total composition, and provided that at least a portion of one or more surfaces of said composition are coated with a metal.

Also disclosed herein is a process for coating a metal onto the surface of the thermoplastic composition by coating said thermoplastic with a metal, wherein the improvement comprises said composition comprises:
(a) at least 30 weight percent of a thermoplastic; and,
(b) about 5 to about 70 weight percent of flat reinforcing fiber; and wherein said weight percents are based on the total composition.

### DETAILED DESCRIPTION OF THE INVENTION

The use of certain terms herein are defined below:

By a “flat reinforcing fiber” (FRF) is meant a fiber that has a noncircular cross section. Preferably the aspect ratio of the cross section (the ratio of the longest cross sectional length to the shortest cross sectional length) is about 1.5 or more, more preferably about 2.0 or more. The cross section may be any shape except circular, and includes, but is not limited to, such elliptical, oval, rectangular, triangular, etc. Such fibers are known, see for instance European Patent Applications 190,001 and 196,194.

By the “thermoplastic polymer” (TP) is meant the common meaning an organic polymeric material that is not crosslinked and which has a glass transition temperature (Tg) and/of melting point (Tm) above 30° C. Tm and Tg are measured using ASTM Method D3418-82, using a, temperature heating rate of 25° C./min. Measurements are made on the second heat. The TM is taken as the peak of the melting endotherm, while the Tg is taken as the inflection point of the transition. To be considered a Tm, the heat of melting for any melting point should be at least about 1.0 J/g.

By a “partially aromatic polyamide” (PAP) is meant a polyamide derived in part from one or more aromatic dicarboxylic acids, where the total aromatic dicarboxylic acid is at least 50 mole percent, preferably at least 80 mole percent and more preferably essentially all of the dicarboxylic-acid(s) from which the polyamide is derived from are aromatic dicarboxylic acids. Preferred aromatic dicarboxylic acids are terephthalic acid and isophthalic acid, and their combinations.

By an “aliphatic polyamide” (AP) is meant a polyamide derived from one or more aliphatic diamines and one or more dicarboxylic acids, and/or one or more aliphatic lactams, provided that of the total dicarboxylic acid derived units present less than 60 mole percent, more preferably less than 20 mole percent, and especially preferably essentially no units derived from aromatic dicarboxylic acids are present. By a “semicrystalline thermoplastic polymer” is meant a thermoplastic which has a melting point above 30° C. with a heat of melting of at least about 2.0 J/g, more preferably at least about 5.0 J/g.

By “coating said thermoplastic with a metal” is meant a conventional process for metal coating a thermoplastic, such an electroless coating, electrolytic plating, vacuum metallization, various sputtering methods, and lamination of metal foils. The process of coating may be a simple one step coating process wherein the metal is “applied” to the TP, but it may also include other steps, such as surface preparation, application of an adhesive, etc. Such processes are well known, for instance U.S. Pat. Nos. 5,762,777, 6,299,942 and 6,570,085, all of which are hereby incorporated herein by reference. Multiple layers of metals, may be applied, of the same or differing compositions.

By an (acid, base, thermally, solvent, etc.) “etchable tiller” is meant a filler present in a polymeric substrate which is at least partially removed and/of whose surface is altered by appropriate (acid, base, thermal, solvent, etc.) treatment, under conditions which do not significantly deleteriously affect the polymeric substrate. Filler is removed, in part or totally, from the surface of the polymeric part by the treatment applied. For example the filler may be material such as calcium carbonate or zinc oxide which can be removed (etched) by aqueous hydrochloric acid, or a material such as zinc oxide or citric acid which may be removed aqueous base, or a material such as poly(methyl methacrylate) which can be depolymerized and removed at high temperatures; or citric acid or sodium chloride which can be removed by a solvent such as water. Since the polymeric matrix of the substrate will normally not be greatly affected by the treatment, usually only the etchable filler near the surface of the polymeric part will be affected (fully or partially removed). The materials that will be etchable fillers are determined by the conditions used for the etching, including the etchant (thermal, solvent, chemical), and the physical conditions under which etching is carried out. For example for any particular polymer etching should not be carried out at a temperature high enough to cause extensive thermal degradation of the polymeric matrix, and/or the polymeric matrix should not be exposed to a chemical agent which extensively attacks the polymeric matrix, and/or to a solvent which readily dissolves the polymeric matrix. Some (very minor) compromise or damage to the polymeric matrix may be acceptable, and indeed a small amount of etching of the polymeric matrix surface itself due to “attack” on the polymer itself may be useful in improving adhesion for the coating and the coating process of choice.

TPs that are useful in the present invention include poly(oxymethylene) and its copolymers; polyesters such as PET, poly(1,4-butylene terephthalate), poly(1,4-cyclohexyldimethylene terephthalate), and poly(1,3-poropyleneterephthatate); polyamides, such as nylon-6,6, nylon-6, nylon-10, nylon-12, nylon-11, and partially aromatic (co)polyamides; liquid crystalline polymers such as polyesters and polyester-amides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfones such as poly(p-phenylene sulfone), polysulfides such as poly(p-phenylene sulfide); polyetherketones such as poly(ether-ketones); poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); and chlorinated polymers such as poly(vinyl chloride), vinyl chloride copolymer, and poly(vinylidene chloride). Also included are thermoplastic elastomers such as thermoplastic polyurethanes, block—copolyesters containing soft blocks such as polyethers and hard crystalline blocks, and block copolymers such as styrene-butadiene-styrene and styrene-ethylene/butadiene-styrene block copolymers. Also included herein are blends of thermoplastic polymers, including blends of two or more semicrystalline or amorphous polymers, or blends containing both semicrystalline and amorphous thermoplastics.

Semicrystalline TPs are preferred, and include polymers such as poly(oxymethylene) and its copolymers; polyesters such as poly(ethylene terephthalate), poly(1,4-butylene terephthalate), poly(1,4-cyclohexyldimethylene terephthalate), and poly(1,3-poropyleneterephthalate); polyamides such as nylon-6,6, nylon-6, nylon-10, nylon-12, nylon-11, combinations thereof and partially aromatic (co)polyamides; liquid crystalline polymers such as polyesters and polyester-amides; polyolefins such as polyethylene (i.e. all forms such as low density, linear low density, high density, etc), polypropylene, fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfones such as poly(p-phenylene sulfone), polysulfides such as poly(p-phenylene sulfide); polyetherketones such as poly(ether-ketones), poly(ether-ether-ketones), and poly(ether-ketone-ketones); and poly(vinylidene chloride). Also included are thermoplastic elastomers such as thermoplastic polyurethanes, block-copolyesters containing so-called soft blocks such as polyethers and hard crystalline blocks, and block copolymers such as, styrene-butadiene-styrene and styrene-ethylene/butadiene-styrene block copolymers.

Preferred TPs have a Tg and/or Tm of about 90° C. or more, preferably about 140° C. or more, and especially preferably about 200° C. or more. Preferably the TP is at least 30 weight percent of the total composition, more preferably at least 50 weight percent based on the total composition. It is to be understood that more than one TP may be present in the composition, and the amount of TP present is taken as the total amount of TP(S) present.

The FRF present in the composition used in the articles of the present invention is a minimum of at least about 5 weight percent, preferably at least about 10 weight percent, and most preferably at least about 20 weight percent, based on the total composition. The FRF is 70 weight percent or less, preferably 50 weight percent or less, and more preferably 40 weight percent of less of the total composition. It is to be understood that any preferred minimum concentration may be combined with any preferred maximum concentration for a preferred concentration for the FRF.

The FRF may be any reinforcing fiber, such as carbon fiber, aramid fiber or glass fiber. Preferably the fiber is synthetic. FRF glass fiber is preferred.

Preferred FRF is chopped fiber, in which the maximum average length of the fibers is about 1 mm to about 20 mm, preferably about 2 mm to about 12 mm. Preferably the large cross sectional dimension of the fiber is less than about 20 μm.

Other ingredients may optionally be present in the TP composition in the articles of the present invention. These include other ingredients typically found in TP compositions, such as fillers, reinforcing, agents (other than FRF), tougheners, pigments, coloring agents, stabilizers, antioxidants, lubricants, flame retardants, and adhesion promotion (especially between the TP is composition and metal coating) agents. A preferred ingredient is an etchable filler, especially when the metal boating is to be done by electroless coating and/or electrolytic coating. Preferred etchable fillers are alkaline earth (Group 2 elements, IUPAC Notation) carbonates, and calcium carbonate is especially preferred. Preferably the minimum amount of etchable filler is 0.5 weight percent or more, more preferably about 1.0 weight percent or more, very preferably about 2.0 weight percent or more, and especially preferably about 5.0 weight percent or more. The preferred maximum amount of etchable filler present is about 30 weight percent or less, more preferably about 15 weight percent or less, and especially preferably about 10 weight percent or less. These weight percents are based on the total TP composition. It is to be understood that any of these minimum weight percents can be combined with any of the maximum weight percents to form a preferred weight range for etchable filler. More than one etchable filler may be present, and if more than one is present, then the amount of etchable filler is taken as the total of those present.

The TP compositions may be made by those methods which are used in the art to make TP compositions in general, and are well known. Most commonly the TP itself will be melt mixed with the various ingredients in a suitable apparatus, such as a single or twin, screw extruder or a kneader. In order to prevent extensive degradation of the flat reinforcing fiber length it may be preferable to “side feed” the fiber. A twin screw extruder may be used for this purpose, so the fiber is not exposed to the high shear of the entire length of the extruder.

Articles of manufacture (before coating) may be formed by conventional methods for TP compositions such as injection molding, extrusion, blow molding, thermoforming, rotomolding, etc. These methods are well known in the art.

Depending on the method used for metal coating, the TP composition, and other factors, good adhesion can obtained between the TP composition and the metal coating. One or more of the TP composition surfaces may be coated, and those surfaces may be partially and/or completely coated. Methods for obtaining good adhesion using the various metal coating methods, are known in the art. As shown in the Examples herein, the TP compositions of the articles disclosed herein surprisingly often have improved delamination resistance to metal in heat cycling testing when compared to compositions containing circular cross section reinforcing fiber.

The metals used in the present invention vary with coating method used. For example, copper, nickel, iron, zinc, and cobalt and their alloys may be readily coated using electrolytic and/or electroless coating methods, while aluminum is commonly used in vacuum metallization. The coating may be of any thickness achievable by the various coating methods, but will typically be about 1 to about 300 μm thick, preferably about 1 to about 100 μm thick.

Average grain size, of the metals deposited may range from 1 nm to about 10,000 nm. One preferred average grain size range, especially for electrolytic and/or electroless plated metals is 1 nm to 100 nm. The effect of the metal coating may, for example, be one or more of improved aesthetics, improved mechanical properties, increased electromagnetic shielding, improved protection of the TP from a corrosive environment, etc.

Articles prepared from thermoplastic compositions containing a “flat” fibrous reinforcing filler and coated with metal show improved resistance to repeated thermal shock. The metal coating may be present to improve appearance and/or to improve mechanical properties or other reasons. These metal coated compositions are useful in various articles such as automotive parts, electronics such as hand held devices, computers, televisions; and housings, toys, appliances, power tools, industrial machinery, and the like.

### Example 1

### Comparative Examples A-B

All parts herein are parts by weight.

The materials used are:

Chimassorb® 944FDL—Poly[[6-[(1,1,3,3-tetramethylbutyl)amino]-s-triazine-2,4-diyl]-[(2,2,6,6-tetramethyl-4-piperidyl]-imino]-hexamethylene-[(2,2,6,6-tetramethyl-4-pipendyl]-imino]] hindered amine light stabilizer available from Ciba; Tarrytown, N.Y. 10591 USA.

Irganox® 1098—a phenolic antioxidant available from Ciba, Tarrytown, N.Y. 10591 USA.

Licomont® CAV 102—a crystallization promoter available from Clariant GmbH, 85005 Augsburg, Germany

Nittobo® glass CSGPA820—a “flat” glass fiber available from Nitto Boseki Co., Ltd., Tokyo 102-8489 Japan (chopped).

Panex® 35 Type 48—a round cross section carbon fiber available from Zoltek Corp., St. Louis, Mo. 63044 USA (chopped)

Polymer A—polyamide 6,6.

Polymer B—an amorphous polyamide made from 1,6-hexanediamine, 70 mole percent isophthalic acid and 30 mole percent terephthalic acid (mole percents based on total amount of dicarboxylic acids present).

PPG 3660—a round cross section fiberglass available from PPG Industries, Pittsburgh, Pa. 15272 USA (chopped).

Stiper-Pflex® 200—a precipitated calcium carbonate available from Specialty Minerals, Inc., Bethlehem, Pa. 18017 USA.

All of the reinforcement fibers listed above are chopped fibers.

The polymeric compositions were prepared by melt blending their components as shown in Table 1 in a twin screw extruder, where the glass and/or carbon were fed into the molten Polymer matrix with aside feeder. Upon exiting the strand die, they are quenched in water and pelletized. The thus prepared compounds were then dried at 100° C. for 6-8 h in dehumidified dryer and then molded into standard ISO 6 cm×6 cm×2 mm test specimens, (plaques), at a melt temperature of 280 to 300° C. and mold temperature of 85-105° C. Compositions are shown in Table 1.

The plaques were etched and activated in a process not using Cr(VI) as shown in Table 2 below. The acid etching solution comprised HCL and ethylene glycol. After etching, the plaques were rinsed then activated via a Pd catalyst and electrolessly plated with Ni, followed with 20 microns of electroplated Cu. Table 2 gives the details of the preparation and plating process.

The peel strength was measured by a Zwick® (or equivalent, device) Z005 tensile tester with a load cell of 2.5 kN using ISO test Method 34-1. An electroplated plaque was fixed on a sliding table which was attached to one end of the tense tester. Two parallel cuts 1 cm apart were made into the metal surface so that a band of metal on the surface 1 cm wide, was created. The table slid in a direction parallel to the cuts. The 1 cm wide copper strip was attached to the other end of the machine, and the metal strip was peeled (at a right angle) at a test speed of 50 mm/min (temperature 23° C., 50% RH). The peel strength was then calculated. Peel values are shown in Table 1.

TABLE 1

| Example | 1 | A | B |
|---|---|---|---|
| Polymer A | 34.15 | 34.15 | 34.15 |
| Polymer B | 15.00 | 15.00 | 15.00 |
| Chimassorb 944FDL | 0.40 | 0.40 | 0.40 |
| Irganox 1098 | 0.20 | 0.20 | 0.20 |
| Licomont CAV 102 | 0.25 | 0.25 | 0.25 |
| Super-Pflex 200 | 10.00 | 10.00 | 10.00 |
| PPG 3660 | | 40.00 | |
| Panex 35 Type 48 | | | 40.00 |
| Nittobo glass | 40.00 | | |
| CSGPA820 | | | |
| Peel Strength, N/cm² | 5.9 | 11.1 | 7.1 |

TABLE 2

| | Bath | | | | |
|---|---|---|---|---|---|
| Step | Purpose | Additives^{a} | Stirring | ° C.^{b} | Minutes |
| 1 | Etching | PM847 | mechanical | 35-50 | 5-20 |
| 2 | Rinse | | no | | 2 |
| 3 | Rinse | | ultrasonic | | 5-15 |
| 4 | Rinse | | no | | 1 |
| 5 | Activator | PM 857 (150 | mechanical | 30 | 5-10 |
| | | ppm Pd) | | | |
| 6 | Rinse | | no | | 2 |
| 7 | Accelerator | PM867 | mechanical | 30 | 1-3 |
| 8 | Rinse | | no | | 1 |
| 9 | Chemical Ni | PM980 R&S | pump | 45 | 10-30 |
| 10 | Rinse | | | | 1 |
| 11 | Galvanic Cu | CuSO4 | mechanical/air | | 40 |
| 12 | Rinse | | | | 1 |

^{a}Aqueous solution Additives marked “PM” are from Rohm & Haas. Where no additive is indicated, only water was used.
^{b}Where no temperature is indicated, ambient temperature used.

A thermal shock test was carried out by heating the test specimens to 180° C. and holding the temperature at 180° C. for 1 h then rapidly cooling to −40° C. and holding the temperature at −40° C. for 1 h, then repeating this cycle until 100 cycles or until significant delamination between the plastic substrate and the metal coating was observed, usually in the form of blisters. The apparatus used consisted of a chamber which contains heating and refrigeration equipment and has the ability to maintain continuous reproducible cycles within the specified temperature requirements and to maintain a constant temperature during each of the respective temperature intervals. The samples were arranged to minimize contact with the chamber surfaces or any mounting racks, and to maximize air flow. This method is modified from ASTM D6944-03. Results of the thermal shock cycling test are shown in Table 3.

TABLE 3

| | Cycles | | | | |
|---|---|---|---|---|---|
| Example | 13 | 24 | 37 | 47 | 100 |
| 1 | OK | OK | OK | Edge | Same as |
| | | | | delamination | cycle 47, eg |
| | | | | | no additional |
| | | | | | delamination |
| A | OK | warp | blisters at | | |
| | | | edge* | | |
| B | blisters, | | | | |
| | warp* | | | | |

*Removed from test due to significant delamination.

As can be seen from Table 3 the composition with “flat” glass reinforcement was much better in the thermal shock test, that round carbon or glass fibers, despite the fact that carbon fibers have a much higher modulus than glass fiber.

1. An article comprising a composition, said composition comprising:
(a) at least about 30 weight percent of a thermoplastic; and
(b) about 5 to about 70 percent by weight of flat reinforcing fiber;
wherein said weight percents are based on the total composition, and provided that at least a portion of one or more surfaces of said article are coated with a metal.

2. The article as recited in claim 1 wherein said flat reinforcing fiber is a glass fiber.

3. The article as recited in claim 1 wherein 0.5 to about 30 weight percent of an etchable filler is also present.

4. The article as recited in claim 3 wherein said etchable filler is an alkali metal carbonate or an alkaline earth metal.

5. (canceled)

6. The article of claim 1 wherein said thermoplastic is a partially aromatic polyamide or partially aromatic polyamide combined with an aliphatic polyamide.

7. The article of claim 1 wherein the polyamide of claim 1 wherein said partially aromatic polyamide comprises aromatic dicarboxylic acid.

8. The article of claim 7 wherein said dicarboxylic acid is terephthalic acid or isophthalic acid or combinations thereof.

9. The article of claim 8 wherein the aliphatic polyamide is selected from the group consisting of nylon-6,6, nylon-6, nylon-10, nylon-12, nylon-11 and combinations thereof.

10. The article of claim 1 wherein said article is suitable for use in high temperature applications, automotive parts, electronic devices, toys, appliances, power tools, or industrial machinery.

11. A process for making the article of claim 1, said process comprising, applying a metal coating to at least a portion of one or more surfaces of said article.

12. (canceled)

13. (canceled)

14. (canceled)

15. The process as recited in claim 11 wherein said metal is applied by vacuum metallization, or electrolytic and/or electroless plating.
